(19) United States
(12) Patent Application Publication
(10) Pub. No.: US 2026/0244651 A1
(43) Pub. Date: Aug. 20, 2026

(54) SYSTEMS AND METHODS FOR PROVIDING DYNAMIC AND DIVERSIFIED INFORMATION RETRIEVAL

(71) Applicant: Verizon Patent and Licensing Inc., Basking Ridge, NJ (US)

(72) Inventors: Karthikeyan KADIRVEL, Chennai (IN); Prabanch Valia Perumal ARASU, Chennai (IN); Varalakshmi GANDI, Medchal (IN); Anil S. KUMAR, Hyderabad (IN)

(73) Assignee: Verizon Patent and Licensing Inc., Basking Ridge, NJ (US)

(21) Appl. No.: 19/055,793

(22) Filed: Feb. 18, 2025

(51) Int. Cl. G06F 16/332; G06F 40/30

(52) U.S. Cl. CPC G06F 16/3325; G06F 40/30

(57) ABSTRACT

A device may receive user stories from a knowledge base based on a similarity measure between a query and the user stories, and may calculate a diversification score based on the similarity measure between the query and the user stories. The device may determine, based on the diversification score, a number of iterations and a retrieval count for each of the iterations, and may iteratively refine a search by removing common parts between the query and the user stories to generate a residual query for each of the iterations. The device may receive additional user stories based on each of the residual queries and a respective retrieval count for each of the iterations until a diverse set of user stories is obtained, and may adjust the number of iterations and retrieval thresholds based on the diversification score.

### BACKGROUND

Information retrieval systems play a role in various industries, especially in sectors where rapid access to relevant and diverse documents or user stories is essential. In particular, retrieving user stories in a manner that captures a broad span of information contained within a large knowledge base is a challenge.

### BRIEF DESCRIPTION OF THE DRAWINGS

FIGS. 1A-1F are diagrams of an example associated with providing dynamic and diversified information retrieval.

FIG. 2 is a diagram of an example environment in which systems and/or methods described herein may be implemented.

FIG. 3 is a diagram of example components of one or more devices of FIG. 2.

FIG. 4 is a flowchart of an example process for providing dynamic and diversified information retrieval.

### DETAILED DESCRIPTION OF EXAMPLE EMBODIMENTS

The following detailed description of example implementations refers to the accompanying drawings. The same reference numbers in different drawings may identify the same or similar elements.

Conventional similarity-based information retrieval systems have inherent limitations, as they tend to return results that closely match a query, often yielding a set of documents or stories that are too homogeneous. This lack of diversity in search results may result in missing relevant information that, while different from the query, may still offer valuable insights or perspectives. Additionally, conventional information retrieval systems typically have a fixed retrieval count, set to return a constant number of documents regardless of a context or a need, potentially either flooding the user with extraneous material or providing an insufficient glimpse of available information. The fixed retrieval count leads to inefficiencies in the information retrieval process and can inhibit optimal utilization of a knowledge base. Thus, current techniques for information retrieval consume computing resources (e.g., processing resources, memory resources, communication resources, and/or the like), networking resources, and/or other resources associated with failing to retrieve diverse information based on a query, providing reduced efficiency in information retrieval, providing ineffective utilization of storage and processing resources during information retrieval, and/or the like.

Some implementations described herein provide a retrieval system that provides dynamic and diversified information retrieval. For example, the retrieval system may receive user stories from a knowledge base based on a similarity measure between a query and the user stories, and may calculate a diversification score based on the similarity measure between the query and the user stories. A user story is a brief, simple description of a feature or functionality from a perspective of an end user. A user story may include a user's role, a desired action or feature, a benefit or value provided, and an acceptance criteria to specify conditions to be satisfied for the user story to be considered complete. For testing, a user story may serve as a basis for creating test cases and scenarios. Testers may utilize the acceptance criteria to develop specific tests that confirm whether the feature works as intended and meets user needs. This ensures that a final product aligns with the user's requirements and expectations, facilitating a user-centered approach to software development and quality assurance. In some implementations, the retrieval system may utilized with information other than user stories, such as a job story, a use case, a problem story, and/or the like.

The retrieval system may determine, based on the diversification score, a number of iterations and a retrieval count for each of the iterations, and may iteratively refine a search by removing common parts between the query and the user stories to generate a residual query for each of the iterations. The retrieval system may receive additional user stories based on each of the residual queries and a respective retrieval count for each of the iterations until a diverse set of user stories is obtained, and may adjust the number of iterations and retrieval thresholds based on the diversification score.

In this way, the retrieval system provides dynamic and diversified information retrieval. For example, the retrieval system may utilize advanced models to parse and understand user queries and match the user queries against a knowledge base. A similarity measure, such as cosine similarity or k-nearest neighbors (KNN) of embeddings, may be employed by the retrieval system to retrieve user stories that are relevant to a query. To enhance the diversity of retrieved information, the retrieval system may compute a diversification score that captures a level of diversity between the query and retrieved user stories. Moreover, the retrieval system may iteratively refine search results by extracting common elements from the query to create a residual query, thereby facilitating the discovery of a diverse range of relevant user stories through multiple iterations. The retrieval system may dynamically adjust iteration count and retrieval thresholds based on the diversification score to improve search result variety. Thus, the retrieval system may conserve computing resources, networking resources, and/or other resources that would have otherwise been consumed by failing to retrieve diverse information based on a query, providing reduced efficiency in information retrieval, providing ineffective utilization of storage and processing resources during information retrieval, and/or the like.

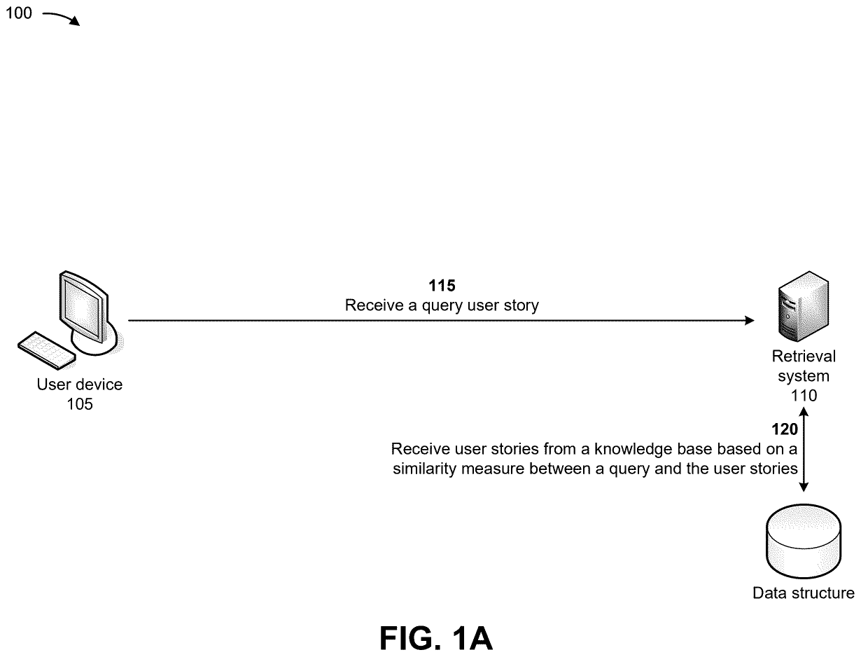

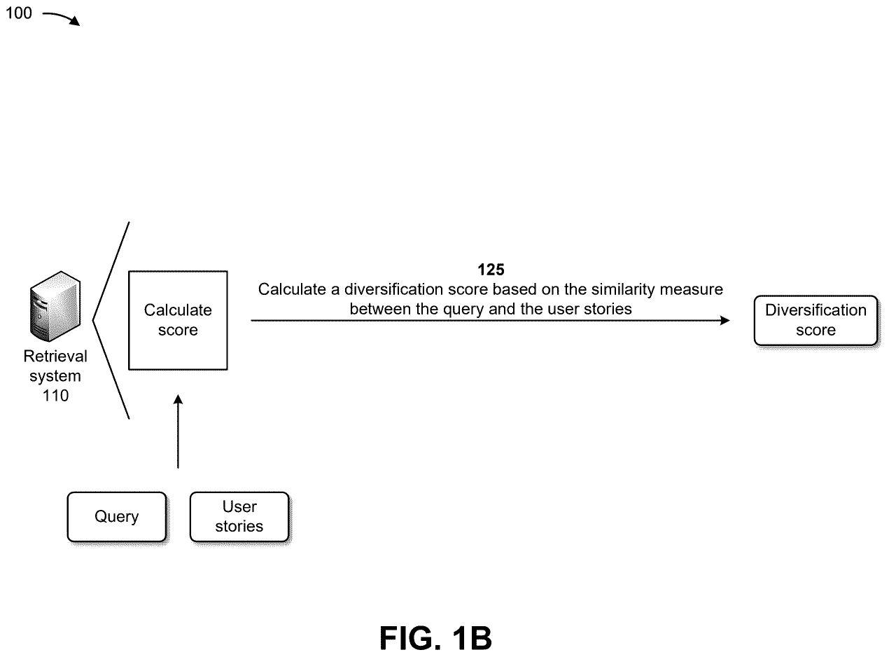

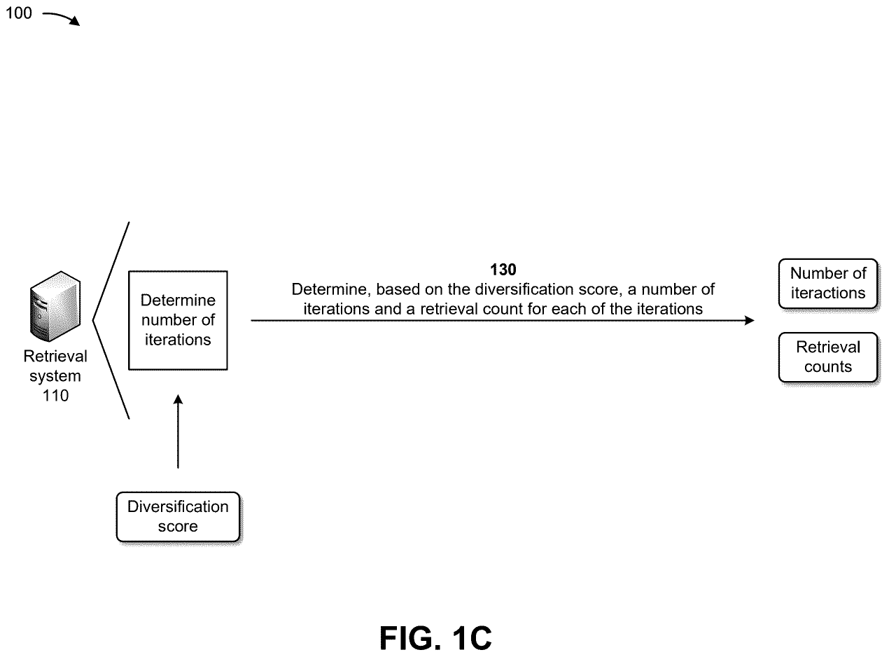

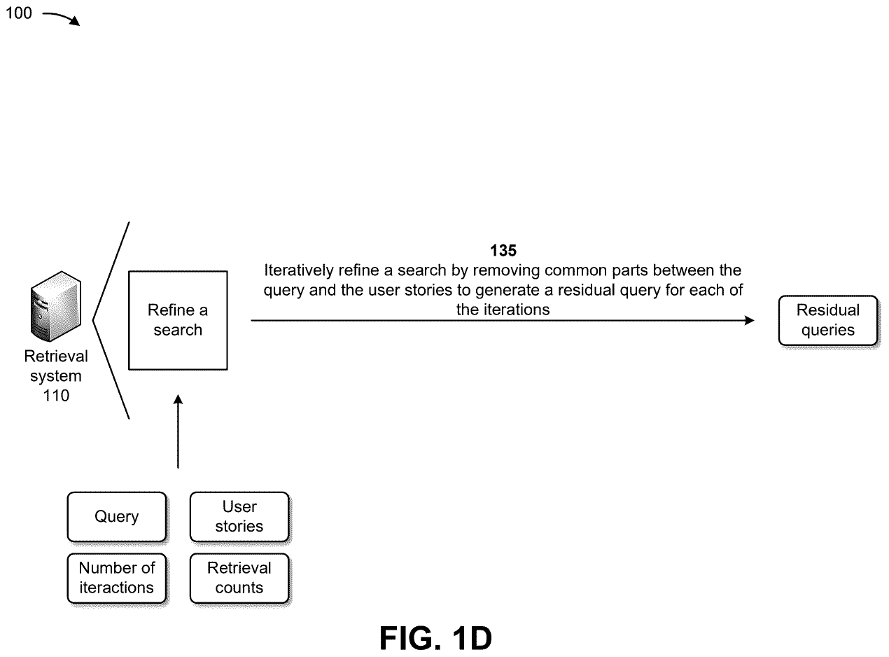

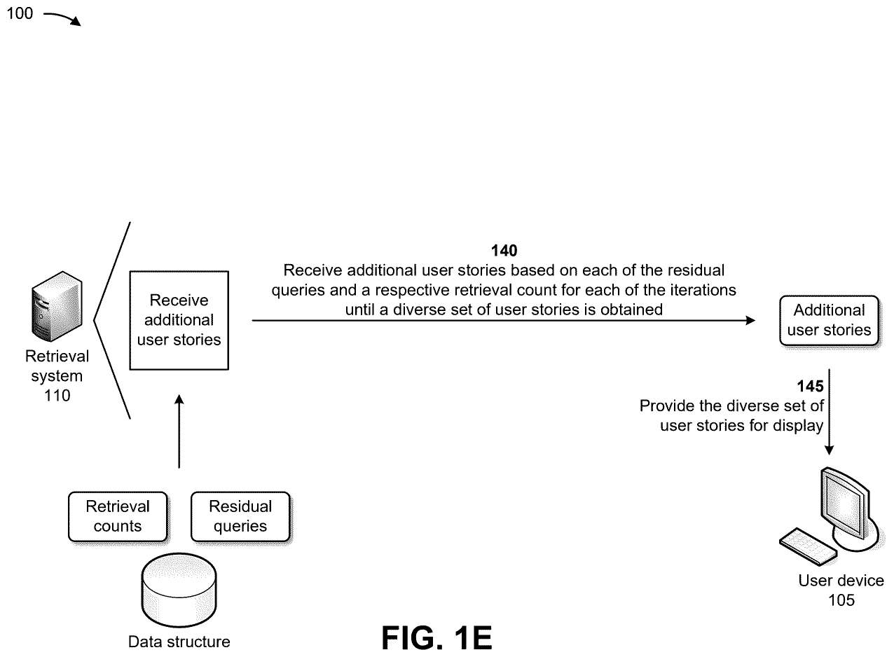

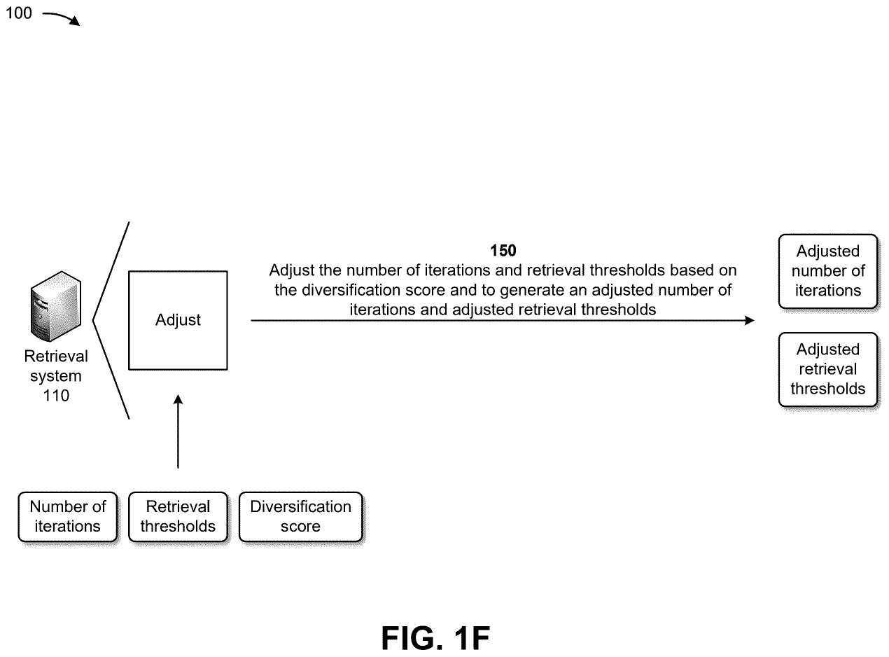

FIGS. 1A-1F are diagrams of an example 100 associated with providing dynamic and diversified information retrieval. As shown in FIGS. 1A-1F, the example 100 includes a user device 105 and a data structure associated with a retrieval system 110. The user device 105 may provide, to the retrieval system 110, queries associated with user stories. The data structure may include a database, a table, a list, and/or the like that stores user stories to be retrieved based on the queries received from the user device 105. The retrieval system 110 may include a system that provides dynamic and diversified information retrieval. Further details of the user device 105, the data structure, and the retrieval system 110 are provided elsewhere herein. Although implementations described herein depict a single user device 105, in some implementations, the retrieval system 110 may be associated with multiple user devices 105.

As shown by FIG. 1A, and by reference number 115, the retrieval system 110 may receive a query user story (also referred to herein as “query”). For example, a user may cause the user device 105 to provide a query user story to the retrieval system 110, and the retrieval system 110 may receive the query user story from the user device 105. The query user story may represent a text document, a narrative, or a similar type of user-generated content that the user wishes to retrieve similar and diverse information about from a knowledge base. In some implementations, the user device 105 may transmit a text query or a user narrative to the retrieval system 110 for processing. Additionally, or alternatively, the retrieval system 110 may process and interpret the query user story submitted by a user device 105, as described below. In some implementations, the retrieval system 110 may store the query user story (e.g., in the data structure).

As used herein, the term “user story” may include a description of a feature or functionality from the perspective of an end user or customer. A user story may be used to capture requirements and guide a development process. User stories are designed to help a development team understand needs and goals of users, ensuring that a final product meets those needs. A user story may include a title that summarizes the feature or functionality; a role (e.g., a customer); a feature (e.g., activity to be performed); a benefit (e.g., a benefit of the feature); an acceptance criteria identifying specific conditions or requirements that must be met for the user story to be considered complete; and/or the like.

As further shown in FIG. 1A, and by reference number 120, the retrieval system 110 may receive user stories from a knowledge base (e.g., the data structure) based on a similarity measure between the query user story and the user stories. For example, the retrieval system 110 may use a similarity measure, such as cosine similarity or KNN of embeddings, to measure a relatedness of the query user story to user stories stored within the data structure. The retrieval system 110 may then retrieve user stories from the knowledge base that match the similarity measure. The retrieval system 110 thereby compiles a set of related user stories correlating with the query user story. In some implementations, the retrieval system 110 may retrieve top similar user stories from the data structure based on the similarity measure (e.g., cosine similarity or KNN of embeddings), as follows:

$$Similarity ( {U}_{q} , {U}_{i} ) = K N N ( E ( {U}_{q} ) , E ( {U}_{i} ) ) ,$$

where U_{q} is the query user story, Uᵢ is an ith retrieved user story, and E is an embedding function.

As shown in FIG. 1B, and by reference number 125, the retrieval system 110 may calculate a diversification score based on the similarity measure between the query and the user stories. For example, the diversification score may capture a diversity level of the retrieved user stories in relation to the query user story. The retrieval system 110 may calculate the diversification score based on averaging the similarity scores of the retrieved user stories and applying a similarity function that outputs a value indicative of diversity. In one example, the retrieval system 110 may calculate the diversification score (D) as follows:

$$D = min ( max ( avg ( Similarity ( {U}_{q} , {U}_{i} ) , 0.001 ) , 0.99 ) .$$

A higher diversification score may indicate a higher degree of variety among the user stories, while a lower diversification score may indicate more homogeneity (e.g., less variety) among the user stories. The diversification score may guide subsequent retrieval processes by influencing a number of iterations and adjustments needed to enhance the diversity of search results based on the query user story.

In some implementations, the diversification score may include a value that ranges from zero (0) to one (1). A diversification score of zero (0) may indicates that a top first retrieval (e.g., of a user story) is exactly similar to the query user story (e.g., a maximum similarity). A diversification score of one (1) may indicate that the top first retrieval is completely dissimilar to the query user story (e.g., a minimum similarity). The diversification score may have an impact on a number of iterations (N). The number of iterations may be calculated based on a retrieval count (R) for each of the iterations, as follows:

$$N = R * ( 1 - D ) .$$

When the diversification score (D) is low (e.g., close to zero), the number of iterations (N) will be high, indicating that more iterations are needed to achieve diversified search results. When the diversification score (D) is high (e.g., close to one), the number of iterations (N) will be low, indicating that fewer iterations are needed as the initial retrievals are already diverse. For example, for a low D (e.g., D=0.1), if R=10 (e.g., a required retrieval count), then N=10*(1−0.1)=10*0.9=9. This means that nine (9) iterations are needed to achieve the required retrieval count with diversified results. For a high D (e.g., D=0.9), if R=10 (e.g., a required retrieval count), then N=10*(1−0.9)=10*0.1=1. This means only one (1) iteration is needed as the initial retrievals are already diverse. For different values of the diversification score (D), the number of iterations (N) will adjust accordingly.

In some implementations, the retrieval system 110 may utilize embeddings to convert user stories into numerical vectors, facilitating enhanced search and retrieval operations. This conversion process allows for the integration of user stories within historical data and assists in identifying relevant test cases. Specifically, the retrieval system 110 may employ embeddings to map user stories into a vector space, enabling a more precise similarity search against a historical repository of test cases. By comparing the embeddings of incoming user stories with those in the historical data, the retrieval system 110 can generate relevant test cases that ensure new functionalities are rigorously tested. Moreover, the embeddings provide a foundation for large language models (LLMs) to refine and generate comprehensive test scenarios based on past implementations, further enriching the development process.

In scenarios where the similarity measure produces minimal scores (e.g., below predefined thresholds), the retrieval system 110 may incorporate mechanisms to handle such edge cases. For example, if the calculated similarity is near zero, indicative of a potential lack of relevant data or retrieval anomalies, the retrieval system 110 may substitute a minimal value (e.g., 0.001) to ensure continuity in retrieval processes. This adjustment prevents scenarios where retrieval operations would halt due to an absence of significant data, thereby ensuring that at least some pertinent information is always retrieved for continued processing and analysis.

As shown in FIG. 1C, and by reference number 130, the retrieval system 110 may determine, based on the diversification score, a number of iterations and a retrieval count for each of the iterations. For example, the retrieval system 110 may use the previously calculated diversification score to influence the number of iterations and retrieval counts needed for each iteration to achieve a diverse set of user stories. A retrieval count may include a quantity of times that the retrieval system 110 retrieves user stories from the knowledge base. The determination involves calculating the number of iterations (N) required, based on the formula N=R*(1−D), where R is the retrieval count and D is the diversification score. Each iteration's retrieval count can then be determined by dividing the total retrieval count (R) by the number of iterations (N) (e.g., R/N), ensuring that the retrieval system 110 dynamically adjusts these parameters to facilitate diverse information retrieval. In some implementations, the retrieval system 110 may dynamically adjust the number of iterations and the retrieval count for each of the iterations. For example, the retrieval system 110 may analyze changes in the diversification score in real-time and may modify the number of iterations and the retrieval count for each of the iterations accordingly to maintain an optimal retrieval process. The number of iterations (N) may be inversely proportional to the diversification score (D) to ensure that the search process adjusts dynamically to achieve diversified results based on the initial similarity.

As shown in FIG. 1D, and by reference number 135, the retrieval system 110 may iteratively refine a search by removing common parts between the query and the user stories to generate a residual query for each of the iterations. For example, the retrieval system 110 may analyze the query user story and the initially retrieved user stories to identify common elements, which can include subjects (e.g., people or entities), actions (e.g., activities or processes), objects (e.g., items or entities), places, times, characteristics, and/or the like. The retrieval system 110 may then generate residual queries by removing these common elements for the iterations. The residual queries may ensure that subsequent iterations focus on retrieving user stories that provide new and diverse information in comparison to the original query and initial retrieved user stories. In some implementations, the retrieval system 110 may employ text analysis techniques, such as clause analysis, to identify text elements and accurately remove common text elements. This iterative refinement may continue through the specified number of iterations, and may enhance the diversity and relevance of the retrieved user stories based on the residual queries.

In some implementations, the retrieval system 110 may identify the common parts between the query user story and the retrieved user stories as follows:

$$Common ( {U}_{q} , {U}_{i} ) = C o m m o n T e r m s ( {U}_{q} , \{ {U}_{i 1} , {U}_{i 2} , … , {U}_{i r} \} ) ,$$

where U_{q} is the query user story and {Uᵢ₁, Uᵢ₂, . . . , Uᵢᵣ} are the top r retrieved user stories. The retrieval system 110 may remove the common parts from the query user story to create a residual query with the remaining unmatched content, as follows:

$${U}_{r esidual} = {U}_{q} - Common ( {U}_{q} , {U}_{i} ) .$$

Additionally, or alternatively, the retrieval system 110 may remove common parts between the query user story and the retrieved user stories using syntax parsing techniques. Syntax parsing techniques may aid in understanding grammatical structures of sentences, allowing for more precise identification of common text elements to be removed.

As shown in FIG. 1E, and by reference number 140, the retrieval system 110 may receive additional user stories based on each of the residual queries and a respective retrieval count for each of the iterations until a diverse set of user stories is obtained. For example, following the iterative refinement process described previously, the retrieval system 110 may use the residual queries to request additional user stories from the data structure. Each iteration may attempt to enhance the diversity of the retrieved user stories by ensuring that each residual query targets different implementations not addressed in previous iterations. This iterative approach may continue until the retrieval system 110 collects a sufficiently diverse set of user stories based on the intended retrieval count for each iteration. In some implementations, the retrieval system 110 may filter out redundant user stories and retain only the unique user stories based on each of the residual queries and a respective retrieval count for each iteration. This process may ensure that only unique user stories are retained, thereby maintaining diversity. Additionally, or alternatively, the retrieval system 110 may utilize different similarity measures during each iteration to refine the search and gather a broad spectrum of user stories based on the residual queries. For example, the retrieval system 110 might use cosine similarity for one iteration and k-nearest neighbors for the next.

As further shown in FIG. 1E, and by reference number 145, the retrieval system 110 may provide the diverse set of user stories for display. For example, once the diverse set of user stories is collected, the retrieval system 110 may structure these stories into a format suitable for presentation. This diverse set of user stories may then be transmitted to the user device 105, and the user device 105 may display the diverse set of user stories to the user. This may ensure that the user receives a wide range of relevant user stories, encompassing various implementations and perspectives related to the original query user story. In some implementations, the retrieval system 110 may integrate user feedback into the iterative process, utilizing the feedback to refine subsequent query adjustments and retrieval counts, ensuring the resulting set of user stories better meets user diversity expectations. For example, if the user indicates that certain stories are not relevant or diverse, the retrieval system 110 may utilize this feedback to adjust future query formulations.

Additionally, or alternatively, the retrieval system 110 may reformulate the residual queries into more nuanced questions using natural language processing techniques, leading to the retrieval of a more varied set of user stories in each iteration. By reformulating the residual queries, the retrieval system 110 may explore different angles and implementations of the initial query. Additionally, or alternatively, the retrieval system 110 may track the relevance and diversification score of each retrieved user story to dynamically decide which user stories to retain and which user stories to discard through the iterations, ensuring that the final set of user stories maintains both relevance and diversity without redundancy. This scoring method allows the retrieval system 110 to prioritize stories that provide the most novel and relevant information to the user.

In some implementations, the retrieval system 110 may repeat this process for the number of iterations (N) or when there is no significant reduction in similarity between the original query and the residual query. If the reduction in similarity is below a certain threshold (e.g., μ=α*(1−D), where α is a user-defined threshold, μ is a threshold derived using D and the user-defined threshold, and μ is used to decide whether a next iteration is needed), the retrieval system 110 may stop the process, as follows:

$$Similarity ( {U}_{q , avg} {\{ {U}_{i 1} , {U}_{i 2} , 2 , … , {U}_{ir} \}}_{n - 1 residual} ) - Similarity ( {U}_{q , a v g} {\{ {U}_{i 1} , {UL}_{i 2} , 2 , … , {U}_{ir} \}}_{n residual} ) < μ ,$$

where U_{q} is the query user story, {Uᵢ₁, Uᵢ₂, . . . , Uᵢᵣ} are the top r retrieved user stories, and n is each iteration count.

As shown in FIG. 1F, and by reference number 150, the retrieval system 110 may adjust the number of iterations and retrieval thresholds based on the diversification score and to generate an adjusted number of iterations and adjusted retrieval thresholds. For example, the retrieval system 110 may adjust the number of iterations and the retrieval thresholds based on the diversification score by dynamically fine-tuning the number of iterations and retrieval thresholds to enhance the diversity and relevance of retrieved user stories. For example, this dynamic fine-tuning may include recalibrating the number of iterations and retrieval thresholds on-the-fly to align with the varying diversification score, thereby adjusting the retrieval parameters to yield more contextually diverse and relevant user stories with each iteration.

Additionally, or alternatively, the retrieval system 110 may adjust the number of iterations and the retrieval thresholds based on the diversification score by continuously modifying the iteration counts and retrieval thresholds to achieve a desired level of variety in the search results. For example, the retrieval system 110 may perform real-time monitoring of the diversification score and may consequently adapt the iteration and threshold parameters to ensure the retrieval of user stories exhibits a broad spectrum of perspectives and information.

The implementations described herein may provide notable advantages and may be particularly effective in specific scenarios. For example, a large knowledge base containing a vast array of user stories may utilize the iterative refinement process to yield varied and comprehensive search results. This may be beneficial when the requirement is to retrieve user stories that cover different aspects or perspectives, ensuring that the results are not just similar to the query, but also diverse.

The benefits of the implementations may include enhanced diversity through the calculation of the diversification score and dynamically adjusted number of iterations. This dynamic adjustment makes the retrieval system 110 adaptable to different retrieval scenarios, optimizing the balance between similarity and diversity. Moreover, the iterative refinement of removing common elements and searching with residual queries helps in obtaining more unique and relevant user stories, providing a richer and more complete set of search results.

In this way, the retrieval system 110 provides dynamic and diversified information retrieval. For example, the retrieval system 110 may utilize advanced models to parse and understand user queries and match the user queries against a knowledge base. A similarity measure, such as cosine similarity or KNN of embeddings, may be employed by the retrieval system 110 to retrieve user stories that are relevant to a query. To enhance the diversity of retrieved information, the retrieval system 110 may compute a diversification score that captures a level of diversity between the query and retrieved user stories. Moreover, the retrieval system 110 may iteratively refine search results by extracting common elements from the query to create a residual query, thereby facilitating the discovery of a diverse range of relevant user stories through multiple iterations. The retrieval system 110 may dynamically adjust iteration count and retrieval thresholds based on the diversification score to improve search result variety. Thus, the retrieval system 110 may conserve computing resources, networking resources, and/or other resources that would have otherwise been consumed by failing to retrieve diverse information based on a query, providing reduced efficiency in information retrieval, providing ineffective utilization of storage and processing resources during information retrieval, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

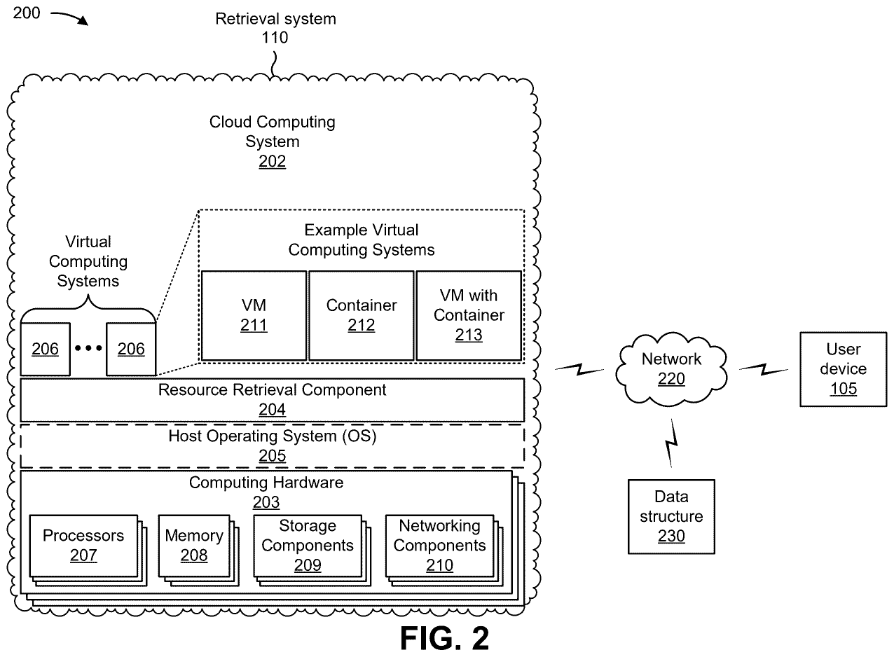

FIG. 2 is a diagram of an example environment 200 in which systems and/or methods described herein may be implemented. As shown in FIG. 2, the environment 200 may include the retrieval system 110, which may include one or more elements of and/or may execute within a cloud computing system 202. The cloud computing system 202 may include one or more elements 203-213, as described in more detail below. As further shown in FIG. 2, the environment 200 may include a user device 105, a network 220, and/or a data structure 230. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

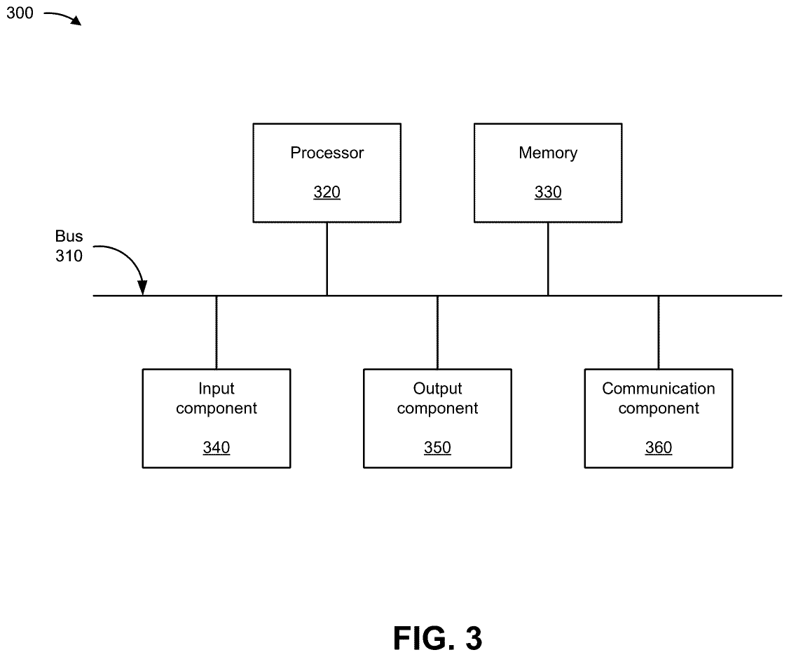

Although the retrieval system 110 may include one or more elements 203-213 of the cloud computing system 202, may execute within the cloud computing system 202, and/or may be hosted within the cloud computing system 202, in some implementations, the retrieval system 110 may not be cloud-based (e.g., may be implemented outside of a cloud computing system) or may be partially cloud-based. For example, the retrieval system 110 may include one or more devices that are not part of the cloud computing system 202, such as a device 300 of FIG. 3, which may include a standalone server or another type of computing device. The retrieval system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The data structure 230 may include one or more devices capable of receiving, generating, storing, processing, and/or providing information, as described elsewhere herein. The data structure 230 may include a communication device and/or a computing device. For example, the data structure 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 230 may communicate with one or more other devices of the environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the retrieval system 110, and/or the data structure 230. In some implementations, the user device 105, the retrieval system 110, and/or the data structure 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

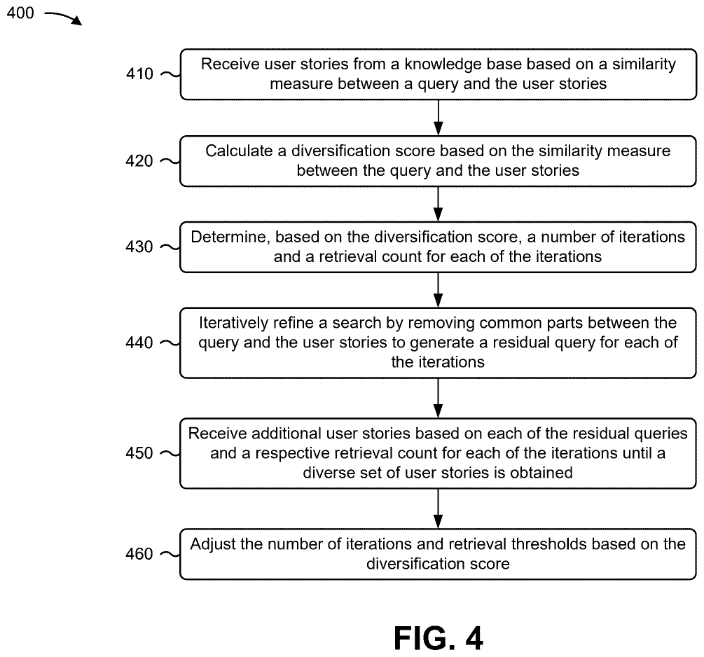

FIG. 4 depicts a flowchart of an example process 400 for providing dynamic and diversified information retrieval. In some implementations, one or more process blocks of FIG. 4 may be performed by a device (e.g., the retrieval system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving user stories from a knowledge base based on a similarity measure between a query and the user stories (block 410). For example, the device may receive user stories from a knowledge base based on a similarity measure between a query and the user stories, as described above. In some implementations, the similarity measure includes one of a cosine similarity or k-nearest neighbors of embeddings. In some implementations, receiving the user stories from the knowledge base includes performing a similarity search based on embeddings of the user stories and the query to identify a set of top similar user stories in the knowledge base, and receiving the set of top similar user stories from the knowledge base.

As further shown in FIG. 4, process 400 may include calculating a diversification score based on the similarity measure between the query and the user stories (block 420). For example, the device may calculate a diversification score based on the similarity measure between the query and the user stories, as described above. In some implementations, calculating the diversification score includes calculating the diversification score based applying a similarity function to the query and the user stories. In some implementations, calculating the diversification score includes substituting a minimum value when the similarity measure produces a value below a predefined threshold.

As further shown in FIG. 4, process 400 may include determining, based on the diversification score, a number of iterations and a retrieval count for each of the iterations (block 430). For example, the device may determine, based on the diversification score, a number of iterations and a retrieval count for each of the iterations, as described above. In some implementations, determining the number of iterations and the retrieval count for each of the iterations includes subtracting the diversification score from one (1) to generate a number, multiplying the number by a previous retrieval count to calculate the number of iterations, and dividing the retrieval count by the number of iterations to calculate the retrieval count for each of the iterations.

As further shown in FIG. 4, process 400 may include iteratively refining a search by removing common parts between the query and the user stories to generate a residual query for each of the iterations (block 440). For example, the device may iteratively refine a search by removing common parts between the query and the user stories to generate a residual query for each of the iterations, as described above.

As further shown in FIG. 4, process 400 may include receiving additional user stories based on each of the residual queries and a respective retrieval count for each of the iterations until a diverse set of user stories is obtained (block 450). For example, the device may receive additional user stories based on each of the residual queries and a respective retrieval count for each of the iterations until a diverse set of user stories is obtained, as described above.

As further shown in FIG. 4, process 400 may include adjusting the number of iterations and retrieval thresholds based on the diversification score (block 460). For example, the device may adjust the number of iterations and retrieval thresholds based on the diversification score, as described above.

In some implementations, process 400 includes identifying the common parts between the query and the user stories based on text elements categorized into one or more of subjects, actions, objects, places, times, or characteristics. In some implementations, identifying the common parts includes performing a text analysis on the text elements.

In some implementations, process 400 includes determining convergence when there is no significant reduction in similarity between the query and the user stories after each of the iterations. In some implementations, process 400 includes adjusting a retrieval threshold dynamically based on the diversification score. In some implementations, adjusting the retrieval threshold includes subtracting the diversification score from one (1) to generate a number, and multiplying the number by a scaling factor to adjust the retrieval threshold dynamically.

In some implementations, process 400 includes obtaining diverse and relevant user stories for complex queries by iteratively refining and adjusting retrieval processes based on the diversification score. In some implementations, process 400 includes utilizing an embedding function to transform the user stories and the query into a numerical space to measure similarity.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, user stories from a knowledge base based on a similarity measure between a query and the user stories;
calculating, by the device, a diversification score based on the similarity measure between the query and the user stories;
determining, by the device and based on the diversification score, a number of iterations and a retrieval count for each of the iterations;
iteratively refining, by the device, a search by removing common parts between the query and the user stories to generate a residual query for each of the iterations;
receiving, by the device, additional user stories based on each of the residual queries and a respective retrieval count for each of the iterations until a diverse set of user stories is obtained; and
adjusting, by the device, the number of iterations and retrieval thresholds based on the diversification score.

2. The method of claim 1, wherein the similarity measure includes one of a cosine similarity or k-nearest neighbors of embeddings.

3. The method of claim 1, further comprising:
identifying the common parts between the query and the user stories based on text elements categorized into one or more of subjects, actions, objects, places, times, or characteristics.

4. The method of claim 3, wherein identifying the common parts comprises:
performing a text analysis on the text elements.

5. The method of claim 1, wherein calculating the diversification score comprises:
calculating the diversification score based applying a similarity function to the query and the user stories.

6. The method of claim 1, wherein determining the number of iterations and the retrieval count for each of the iterations comprises:
subtracting the diversification score from one (1) to generate a number;
multiplying the number by a previous retrieval count to calculate the number of iterations; and
dividing the retrieval count by the number of iterations to calculate the retrieval count for each of the iterations.

7. The method of claim 1, further comprising:
determining convergence when there is no significant reduction in similarity between the query and the user stories after each of the iterations.

8. A device, comprising:
one or more processors configured to:
receive user stories from a knowledge base based on a similarity measure between a query and the user stories,
wherein the similarity measure includes one of a cosine similarity or k-nearest neighbors of embeddings;
calculate a diversification score based on the similarity measure between the query and the user stories;
determine, based on the diversification score, a number of iterations and a retrieval count for each of the iterations;
iteratively refine a search by removing common parts between the query and the user stories to generate a residual query for each of the iterations;
receive additional user stories based on each of the residual queries and a respective retrieval count for each of the iterations until a diverse set of user stories is obtained; and
adjust the number of iterations and retrieval thresholds based on the diversification score.

9. The device of claim 8, wherein the one or more processors, to receive the user stories from the knowledge base, are configured to:
perform a similarity search based on embeddings of the user stories and the query to identify a set of top similar user stories in the knowledge base; and
receive the set of top similar user stories from the knowledge base.

10. The device of claim 8, wherein the one or more processors are further configured to:
adjust a retrieval threshold dynamically based on the diversification score.

11. The device of claim 10, wherein the one or more processors, to adjust the retrieval threshold, are configured to:
subtract the diversification score from one (1) to generate a number; and
multiply the number by a scaling factor to adjust the retrieval threshold dynamically.

12. The device of claim 8, wherein the one or more processors are further configured to:
obtain diverse and relevant user stories for complex queries by iteratively refining and adjusting retrieval processes based on the diversification score.

13. The device of claim 8, wherein the one or more processors, to calculate the diversification score, are configured to:
substitute a minimum value when the similarity measure produces a value below a predefined threshold.

14. The device of claim 8, wherein the one or more processors are further configured to:
utilize an embedding function to transform the user stories and the query into a numerical space to measure similarity.

15. A non-transitory computer-readable medium storing a set of instructions, the set of instructions comprising:
one or more instructions that, when executed by one or more processors of a device, cause the device to:
receive user stories from a knowledge base based on a similarity measure between a query and the user stories;
calculate a diversification score based on the similarity measure between the query and the user stories;
determine, based on the diversification score, a number of iterations and a retrieval count for each of the iterations;
identify common parts between the query and the user stories based on text elements categorized into one or more of subjects, actions, objects, places, times, or characteristics;
iteratively refine a search by removing the common parts between the query and the user stories to generate a residual query for each of the iterations;
receive additional user stories based on each of the residual queries and a respective retrieval count for each of the iterations until a diverse set of user stories is obtained; and
adjust the number of iterations and retrieval thresholds based on the diversification score.

16. The non-transitory computer-readable medium of claim 15, wherein the one or more instructions, that cause the device to identify the common parts, cause the device to:
perform a text analysis on the text elements.

17. The non-transitory computer-readable medium of claim 15, wherein the one or more instructions, that cause the device to calculate the diversification score, cause the device to:
calculate the diversification score based applying a similarity function to the query and the user stories.

18. The non-transitory computer-readable medium of claim 15, wherein the one or more instructions, that cause the device to determine the number of iterations and the retrieval count for each of the iterations, cause the device to:
subtract the diversification score from one (1) to generate a number;
multiply the number by a previous retrieval count to calculate the number of iterations; and
divide the retrieval count by the number of iterations to calculate the retrieval count for each of the iterations.

19. The non-transitory computer-readable medium of claim 15, wherein the one or more instructions further cause the device to:
determine convergence when there is no significant reduction in similarity between the query and the user stories after each of the iterations.

20. The non-transitory computer-readable medium of claim 15, wherein the one or more instructions, that cause the device to receive the user stories from the knowledge base, cause the device to:
perform a similarity search based on embeddings of the user stories and the query to identify a set of top similar user stories in the knowledge base; and
receive the set of top similar user stories from the knowledge base.
